(19) United States
(12) Patent Application Publication
(10) Pub. No.: US 2003/0061121 A1
(43) Pub. Date: Mar. 27, 2003

(54) Catalog and item identifier for configurable items

(76) Inventor: Norman Ken Ouchi, San Jose, CA (US)

Correspondence Address: NORMAN KEN OUCHI, 20248 VIEW CREST CT, SAN JOSE, CA, 95120, US

(21) Appl. No.: 09/962,953

(22) Filed: Sep. 22, 2001

(51) Int. Cl. G06F 17/60

(52) U.S. Cl. 705/27

(57) ABSTRACT

This invention is related to electronic information transfer between trading partners and more particularly to the use of a catalog and item identifier to specify an item that has a number of configurations or features so that the specified item can be ordered. In the present invention, a configured item is associated with a two-part item identifier where one part is a standardized, fixed format field and the second part is a variable format field. A catalog provides a means to generate the two-part item identifier based on the description of the configured item. The item identifier can be used to order an item matching the description of the configured item.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

This invention is related to electronic information transfer between trading partners and more particularly to the use of a catalog and item identifier to specify an item that has a number of configurations or features so that the specified item can be ordered.

### BRIEF SUMMARY OF THE INVENTION

In the present invention, a configured item is associated with a two-part item identifier where one part is a standardized, fixed format field and the second part is a variable format field. A catalog provides a means to generate the two-part item identifier based on the description of the configured item. The item identifier can be used to order an item matching the description of the configured item.

### BACKGROUND OF THE INVENTION

A company sells items to their trading partners and lists the description of these items in a catalog. To aid in clearly specifying the item, the company assigns to each item an item identifier, called a part number or part name, which is used for order and delivery of the item. The item identifier is usually a short compact string of digits, letters, and special characters that may be processed by computer programs. People working with these item identifiers learn to recognize the items by their item identifiers. Since the item identifier need only be consistent within a company, the structure, format, meaning, etc. are unique for each company. Hence, each company has its own item identification system. When buyer orders an item from a seller, the buyer must order the item using the identification system of the seller. The seller provides a catalog so that buyers can find the item using the description provided by the seller and use the item identifier to order the item. The catalog and item identifier mechanism has worked for a very long time and is a corner stone for commerce.

The item identifier has a one-to-one mapping to the “orderable” item. As an example, a sugar provider sells sugar. However, the sugar is not sold as “sugar” but as bags of sugar and the bags are in a finite set of sizes: 10 pound bag, 50 pound bag, 100 pound bag, etc. Each bag size is assigned an item identifier so that a buyer can purchase a specific number of specific size bags: 10 pound bag-S10, 50 pound bag-S50, and 100 pound bag-S100. So if the sugar supplier received an order for “Item identifier: S50; Quantity: 6”, then six 50 pound bags were ordered. There are two important observations in this example:

1) The length of the item identifier is not fixed. The item identifier for the 10 pound bag is three characters long and the item identifier for the 100 pound bag is four characters long. This difference was not important when the orders were placed and processed by hand. However, the computer systems have a finite field to store the item identifier and variable field lengths are a problem. Long field lengths is a real problem if the item identifier is longer than the field length used by the computer system or the programs that process the item identifiers.

2) The item identifier in the example has information related to the item. That is the item identifier “S10” identified the 10 pound bag and “S50” identified the 50 pound bag. One can imagine if the sugar supplier sold a 75 pound bag that the identifier would be “S75”. The configuration for the sugar, the bag size, is part of the item identifier. In some item identifier assignments, the item identifiers do not have a relationship to the characteristics of the item and the catalog must be used to determine the relationship between item and the associated item identifier. In the sugar example, the 10 pound bag could have been assigned the item identifier: 1234, the 50 pound bag the item identifier: 1256, the 100 pound bag the item identifier: 568. As long as there is a one-to-one relationship between a item and its item identifier, the item identifier can function. The Universal Product Code is an example of item identifiers that do not have a relationship to the characteristics of the product.

The internally defined catalog structure and part number mechanisms worked well for processes that had people executing the process steps. People can accommodate high levels of variability and still function. However, computer systems are now used to execute these processes. These systems and the programs that support the processes are fast, accurate, and dumb. Small variations require that the programs be modified or rewritten. There are significant advantages for industries to standardize the item identifier and the catalog. The item identifier for most grocery items is the Universal Product Code, UPC, which we all see as the bar code on the item. The UPC is twelve-digit string where six digits identify the selling company and five digits are assigned by the company to identify their products. One digit is a check digit. The company has freedom to assign their five digits as item identifiers for its products. Most companies believe that they have less than 100,000 orderable products so the five digit limit appears to be workable. The grocery and other industries have had significant success in implementing the UPC and gained substantial financial benefit through the changes in the business processes supported by the UPC. However, the electronics industry lead by a strong industry consortium, RosettaNet, and a strong standards organization, the Uniform Code Council, has had difficulty in adopting the global successor to the twelve digit UPC, the fourteen digit Global Trade Item Number, GTIN. The GTIN, like the UPC, identifies the company that sells the item and provides up to five digits for the company to assign to its items. RosettaNet defines “Partner Interface Processes”, PIP's, the business transactions between trading partners to accomplish elements of larger processes. An example is PIP 2A9: Query Technical Product Information which defines how one trading partner can query the catalog of another over the Internet and receive a response with either the item identifier of an item matching the description of the item in the query or an indication that there is no matching item. The PIP defines the XML message formats and the state behavior of each partner depending on the decisions indicated in the XML messages. Another example is PIP 3A4: Manage Purchase Order which defines how one trading partner can send a purchase order to a trading partner and the management of the purchase order if changes are made. RosettaNet and the UCC want to standardize the definition of the item identifier in the XML messages and have chosen the GTIN as the standard. While it may appear that many of the items are simple and can be assigned a GTIN, closer inspection reveals a level of complexity that will be difficult to accommodate with the use of the GTIN as currently defined.

Many of the electronic items have a wide range of configurable options in the specification of the orderable item. As an example, a capacitor, a simple part, has a capacitance value, tolerance, resistance, body size, package, etc. These values are encoded in the part number. In the example of the sugar supplier, the bag size was encoded in the part number. The capacitor suppliers encode the values for each of these variables into the part number using algorithms that assign portions of the item identifier to each of the variables. For example, as illustrated in FIG. 1, the item identifier for a Kemet Electronics Corp. capacitor is C0805C103K5RAC where the first character encodes the capacitor type (Ceramic), the next four characters encode the capacitor body size (0805), the next encodes the specification (Standard), the next three encode the capacitance value (0.50 pF.), the next character encodes the tolerance, the next the resistance value, etc. Numbers and letters are used. Thus, in a small number of characters, 6 to 20, the configurations are covered. However, the possible combinations are very large. Six alphanumeric characters can encode over two billion combinations. Most combinations will never be used. Assigning a GTIN for each of the possible combinations is not possible: 1) The number of possible combinations would rapidly consume the GTIN possibilities and 2) The mapping of combinations to GTIN values would require a table with as many rows as combinations. The algorithms that map the variable values to a finite number of characters are very effective. However, this structure is not consistent with the GTIN as currently defined except for those cases where the algorithm can map the variable values into the five digits that a company can control. There have been discussions among the RosettaNet members as to how the current algorithms might be used but there has been little progress. The algorithms for each company, even those who manufacture identical items, for example capacitors, are unique to each company. The systems of each company are built around the part number so this will not be easy to change. However, RosettaNet has achieved a significant milestone in the definition and agreement of the catalog structure, the taxonomy of how the characteristics and values are expressed in the description for each item. Thus, searching for and defining each item can be done in a consistent process and the resulting definition for identical items from different manufacturers can be the same. The RosettaNet vision is illustrated in FIG. 2 where a buyer can connect through the Internet 125 to a seller's Web site using a web browser 127 or a business-to-business server 126 and send an item description 1 to the seller's electronic catalog 2 using the RosettaNet PIP 2A9: Query Technical Product Information. The catalog 2 responds with the item identifier 3 if the seller has an item matching the description. The buyer can then order the item using the item identifier provided by the seller's electronic catalog by sending an order 4 using the RosettaNet PIP 3A4: Manage Purchase Order to the seller's order processing system 5. The order shipment, tracking, delivery, etc. can use the item identifier and associated information to facilitate these business processes. The combination of bar codes on the physical items and associated information in systems has proven to be a very effective for physical item logistics. Note that the bar code does not need to carry all of the information but just needs to be a unique identifier so that information can be accessed in the systems. An example of use of bar codes in this manner is the bar code on overnight delivery packages. The bar code does not have any of the information about the destination, sender, etc. It serves as a unique key, an identifier, to access the information in the overnight delivery service computer systems. All of the information about the package is kept in these systems.

The function of the item identifier is for the supplier or seller to provide the requested item. The buyer uses the seller's catalog to determine the item identifier. Essentially the seller is telling buyers, “If you want to order the item you described, ask for it using the item identifier that is provided as the response”. In the past, the item identifier was processed by people and needed to be short enough so that a person could write it in an order form with minimum transcription errors. However, the orders are created by computer systems and processed by computer systems. The item identifiers can now be much longer so that formats and processes can be standardized.

The RosettaNet standard processes, catalog taxonomies, and the use of GTIN as the item identifier are not sufficient to support the requirements of the electronics industry and other industries where the items have a high level of configuration. The objective of RosettaNet is to provide the structure so that trading partners can rely on standard processes and data formats such that third parties can provide much of the systems and software and custom development can be avoided or at least minimized. This also permits connection to new trading partners with a minimum of effort and delay. Solving the configured item will provide a complete framework for RosettaNet and thus, provide the benefits of a standard. In addition, many of the systems used for planning and purchasing items have limited item field lengths and may not be able to accommodate long item identifiers. The solution must permit use of current systems.

### BRIEF DESCRIPTION OF DRAWINGS

FIG. 1 illustrates the encoding of a Kemet Electronics Corp. capacitor configuration values into the Kemet item identifier.

FIG. 2 illustrates the processes where a buyer sends a request to a seller's catalog for an item identifier using an item description, receives an item identifier, and uses the item identifier in an order to purchase the item.

FIG. 3 illustrates the item description request to the catalog, the response with a two-part item identifier, and the item order with the item identifier.

FIG. 4 illustrates the seller's system translations of the item description in RosettaNet form to an internal catalog process, the internal catalog response to the RosettaNet form with a two-part item identifier, and the item order in RosettaNet form with a two-part item identifier to an internal order process

FIG. 5 illustrates the buyer's system translations where the internal item identifier is translated to and from RosettaNet form in the Business-to-business server.

### DESCRIPTION OF THE INVENTION

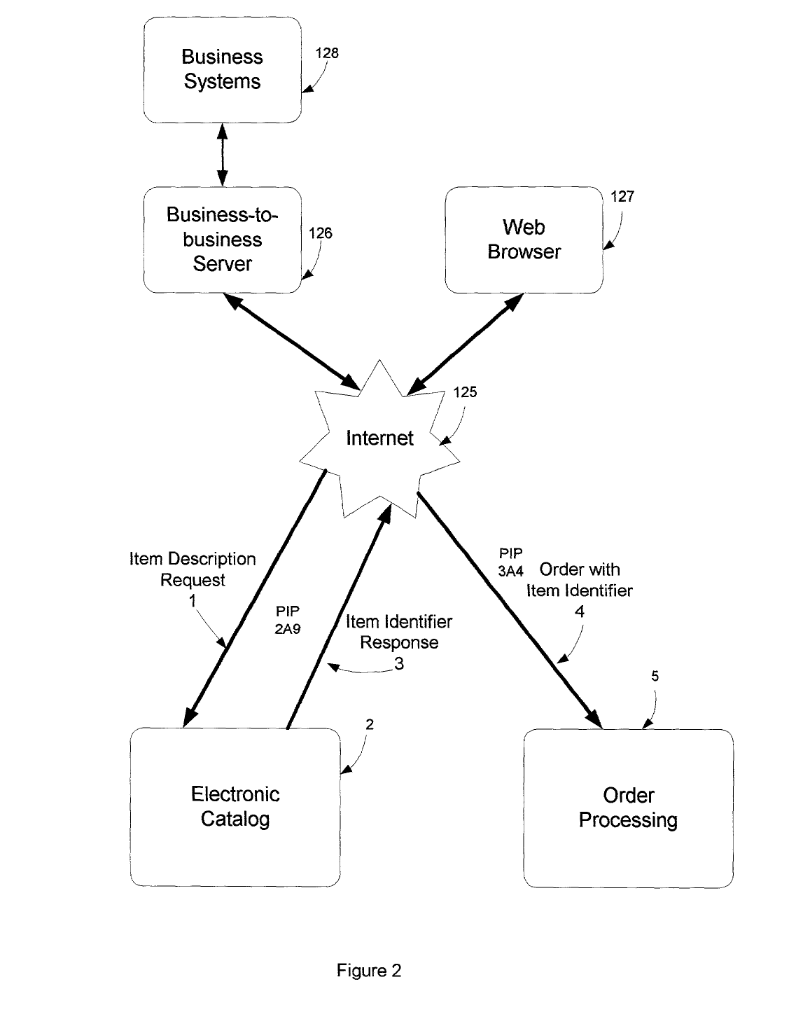

The key objective of a standard is to enable those who conform to the standard to easily execute transactions with others who conform to the standard. The process illustrated in FIG. 2 is the desired goal: a buyer can send a description to a seller and receive an item identifier for an item fitting the description; the item identifier is used to order the described item. However, the constraints of the 14 digit GTIN do not permit reasonable transfer of information to identify configured items. Recall that the UPC and its successor, the GTIN evolved to support bar code labels for point of sale processing. RosettaNet and other XML based standards are to support the processes and information passed between trading partners and need not be constrained to the 14 digit GTIN for item identification. However, the GTIN has significant function that can be used. The GTIN is fixed length, the “owner” of the GTIN is identified in a standard set of digits and the owner registration processes are robust and used globally, the GTIN can be used as originally envisioned for items with limited configurations by assigning each configuration its own GTIN. However, the GTIN must be augmented to accommodate configurable items, which happen to be a large proportion of the items in the electronics industry. Most suppliers, as illustrated by Kemet, have an item identification algorithm that maps the configuration values into characters that are then concatenated with other characters to form the item identifier. Suppliers have their own unique algorithms. It is not reasonable to expect that the algorithms will be standardized. However, RosettaNet and its members have agreement on the catalog taxonomy and the XML message structure to describe a desired item. The supplier can keep their own internal representation of the catalog but will accept the RosettaNet XML description and find in their catalog the item that matches the description (if it is in the catalog).

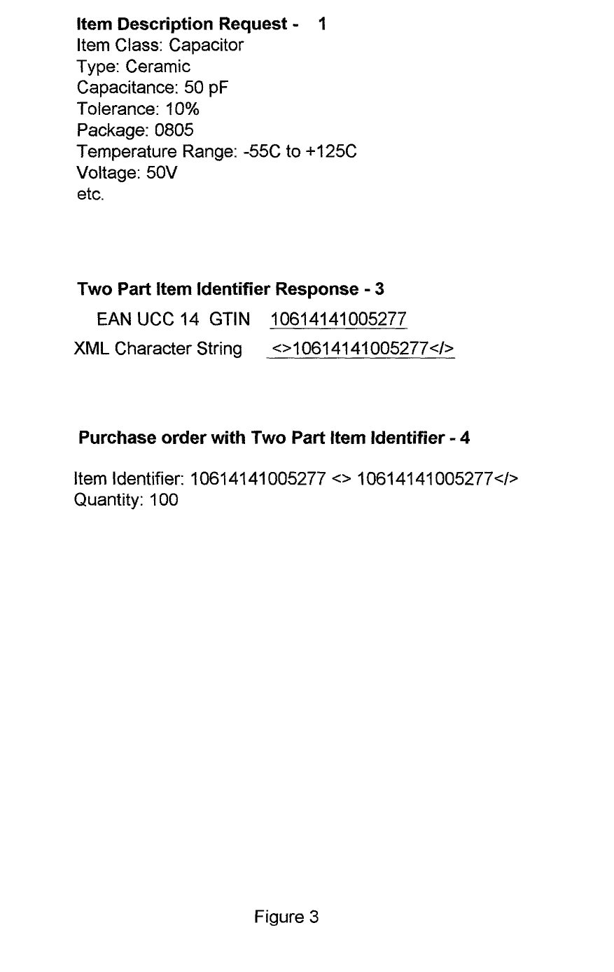

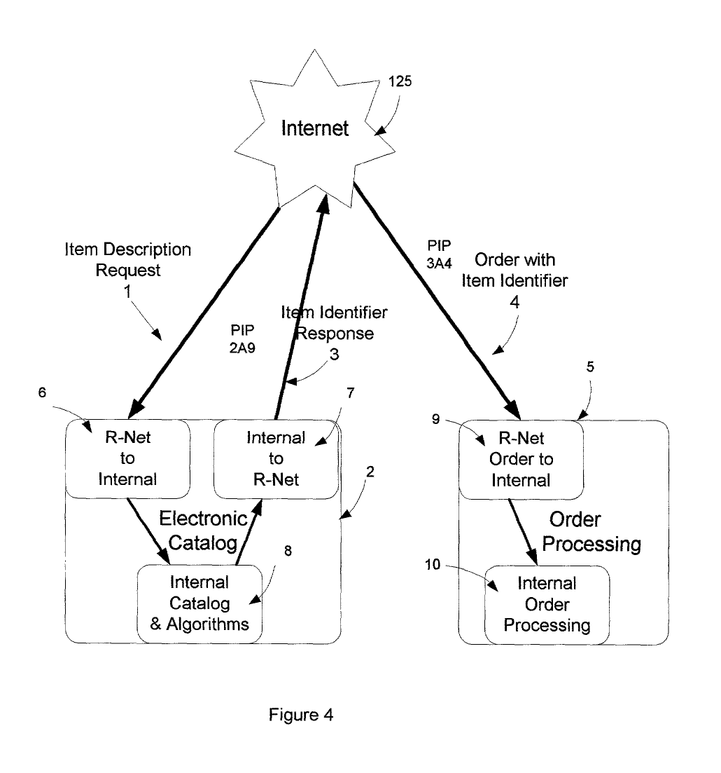

The present invention defines a two-part item identifier: the GTIN and an optional XML defined character string that provides the configuration information. The GTIN is as defined by the UCC and RosettaNet. The supplier defines the XML extension. FIG. 3 illustrates the key contents of the Item Description Request 1, the two-part item identifier in the Item Identifier Response 3, and the Purchase Order with the item identifier 4. The XML syntax and format of these messages are defined by the RosettaNet PIP's 2A9 and 3A4. The maximum length of the extension can be included in the RosettaNet standard. However, it is not envisioned that the buyer's system 128 will store the GTIN and extension since it may have limited field size for the item identifier but that this will be kept in the Business-to-business Server 126 that is built on more modern technology where field size is not an issue. The buyer's system will be given a short reference value that is used as the internal item identifier. The Business-to-business server substitutes the GTIN and optional XML string for the reference value as PIP messages are sent to the trading partners and the reference value is substituted for the GTIN and optional XML string as PIP messages are received and passed to the buyer's systems. FIG. 4 illustrates the seller's catalog and order entry systems. The buyer sends the item description request 1 in the RosettaNet standard format with the parameters describing the desired item. The R-Net to Internal function 6 maps the item description into the internal form for accessing the seller's internal catalog and item identifier generation algorithms 8. If an item matches the description, the catalog returns an internal item identifier that is composed of a base item identifier and an XML character string that contains the configuration values as needed by the seller to completely specify the item. Note, the algorithms to form the character string may be the same as currently used by the seller or may be used with small modification. The base item identifier and configuration value string is passed to the Internal to R-Net function 7 that maps the base item identifier and configuration value string into a GTIN and an XML string. These are sent to the requesting buyer as a RosettaNet XML message. When the buyer places an order 4, the purchase order XML message contains the GTIN and the XML string as the item identifier. The R-Net to Internal Order function 9 maps the GTIN and XML string into the internal representation of the item so that the Internal Order Processing 10 can begin to fulfill the order. Note that the seller can still utilize a significant portion of the seller's existing systems. The XML string can in fact be the item identifier that the seller's algorithms generate before the use of the GTIN or RosettaNet processes and XML messages. Many sellers do not have catalogs that support the RosettaNet taxonomy and will build new catalogs and migrate items in the older catalog to the new catalog. The current seller algorithms to generate the value string may change because of the new catalog structure. Note that these changes or new function need only be developed once and seller can support for all RosettaNet compliant trading partners.

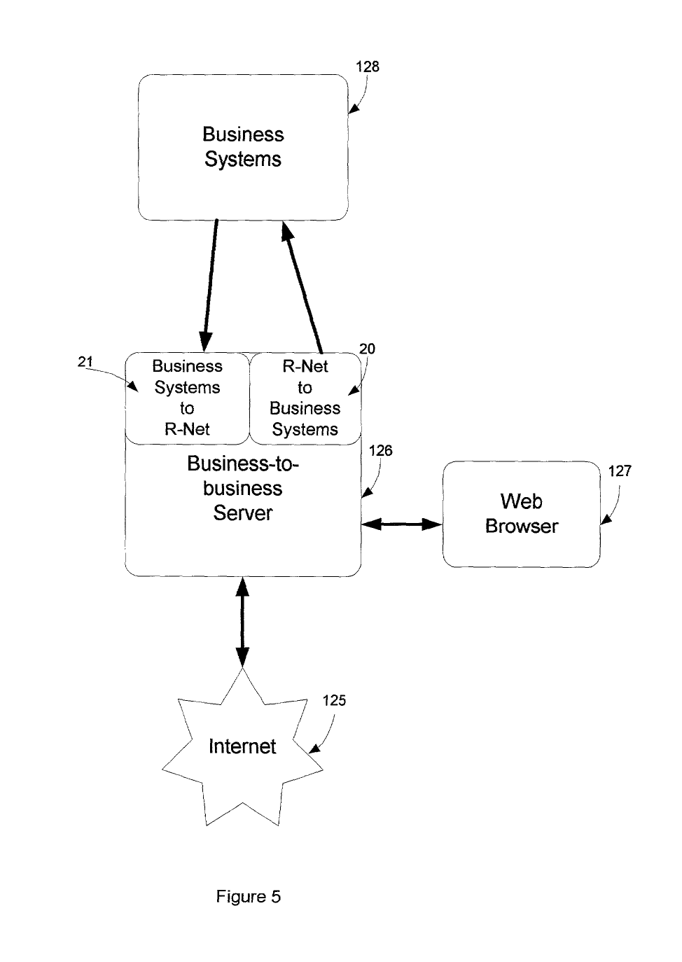

FIG. 5 illustrates the functions needed by the buyer to query the electronic catalog and to order an item from a seller. The buyer system may only support item identifier field length similar in length to the current item identifier. The Business Systems to R-Net 21 and R-Net to Business Systems 20 provide a mapping or algorithm for mapping between the business systems form and the RosettaNet GTIN and XML string. It is envisioned that the full GTIN and XML string are stored in the Business-to-business and are inserted into outbound transactions, such as the purchase order created by the buyer's business systems, by substituting the shorter buyer's internal item identifier with the full GTIN and XML string. For inbound transactions, the reverse translation is performed where the internal item identifier replaces the GTIN and XML string. In addition, most implementations of the RosettaNet PIP 2A9: Query Technical Information provides a Web interface so that searches for items may be done manually or to handle exception conditions. The Business-to-business server 126 provides a Web browser 127 to integrate the functions of finding items matching descriptions and setting up the translation tables in the Business Systems to R-Net 21 and R-Net to Business Systems 20 processes.

The present invention provides a two-part item identifier that consists of a fixed length, fixed format standard segment and an optional variable length, variable format segment to identify the configuration of a configurable item. In one implementation, the fixed segment is defined by the UCC GTIN specification and standard and the variable segment is an XML string defined by the seller's algorithm for creating an item identifier from an item description. A process for a buyer to send an item description to a seller's catalog to obtain the item identifier is described. In one implementation, the RosettaNet 2A9: Query Product Technical Information is described. A process for a buyer to send an order with the item identifier is described. In one implementation, the RosettaNet 3A4: Manage Purchase Order is described.

A means for the seller systems to be adapted to use the two-part item identifier is described by use of an R-Net to Internal adapter to transform the RosettaNet item description query to the seller's internal catalog description query; use of an Internal to R-Net adapter to transform the seller's internal item identifier generation algorithms to the XML string and GTIN; use of an R-Net to Internal Order adapter to transform the XML string and GTIN in the item order into the internal order format of the seller's systems to process the order.

A means for the buyer's systems to be adapted to use the two-part item identifier is described by the use of an R-Net to Business systems adapter to transform the two-part item identifier into an internal item identifier usable by the buyer's systems for inbound messages and a Business systems to R-Net adapter to transform the internal identifier into the two-part item identifier for outbound messages. A Web browser interface is described for manual catalog searching and exception processing so that the two-part item identifiers provided in the catalog queries can be easily added to the transformation adapters. It is envisioned that these adapters are part of a Business-to-business server but may be integrated into other business systems or may be packaged as stand-alone adapters.

### DESCRIPTION of a PREFERRED EMBODIMENT

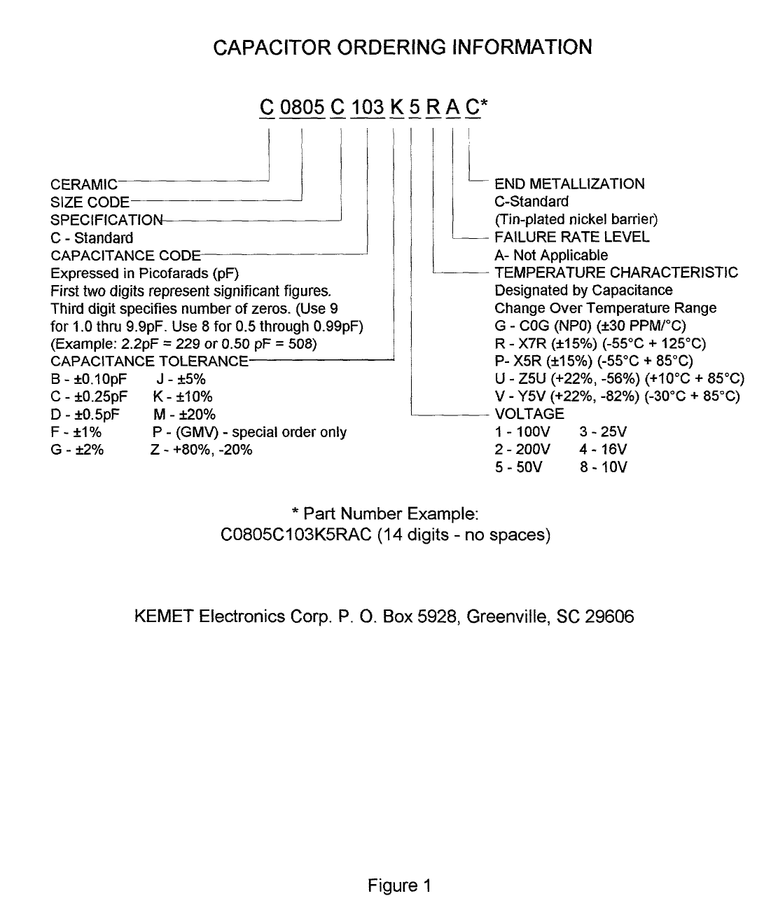

The adapters are implemented as software programs written in Java, C++, Microsoft Visual Basic, or a number of programming languages. The programs may use a database for storing translation tables and other information. Database programs are available from Oracle, IBM, Microsoft, and many other providers. These programs and databases execute in computers manufactured by, for example, IBM, Sun, Dell, and Compaq. The computers may be, for example, PC's, workstations, mainframes, and hand-held computers. The computers may have an operating system such as UNIX, LINUX, Microsoft 2000, and IBM OS/9000. The computer is connected to a network that may be, for example, a LAN, WAN, Internet, Intranet, wireless LAN, or wireless Internet. The adapter program to transform an item description query in RosettaNet XML form into the internal catalog query form of a seller's catalog is highly dependent on the seller's catalog and associated programs. Much of the transformation is a mapping of fields of the RosettaNet query into the fields of the seller's query. The data values must also be translated from the RosettaNet XML form to the internal seller's form. These translations may be embodied as algorithms, e.g. moving values from a RosettaNet field, multiplying the value by a factor and inserting in to a seller's field; as translations, e.g. a value in a RosettaNet field is used as a search argument in a relational database to find its translation into a value in the seller's internal form; or a combination of these operations. The other adapter programs for the seller for translating the RosettaNet item identifier into and from the internal form are primarily algorithms. For example, each configurable base item can be assigned a GTIN. In the case of Kemet capacitors, all ceramic surface-mount capacitors can share the same GTIN. Tantalum capacitors are assigned another GTIN, etc. The algorithm for generating the XML string can be the same algorithm that generates the current item identifier as illustrated in FIG. 1. The Internal to R-Net adapter determines from the catalog if the capacitor is ceramic and if so inserts the GTIN for ceramic capacitors and appends the current item identifier as an XML string and outputs the two-part item identifier. The R-Net Order to Internal adapter accepts the two-part item identifier, removes the GTIN, and converts the XML string into the current identifier used by the internal systems.

The Business systems to R-Net and R-Net to Business systems adapters use a relational database to translate between the two-part item identifier and an internal item identifier. Each internal item represents an item that may be purchased from a supplier. A database row contains two fields: the internal item identifier and the two-part item identifier. The number of database rows will be equal to the number of unique items that the buyer buys. The Business system to R-Net adapter accepts outbound transactions from the internal systems with internal item identifiers and translates the internal item identifiers into the two-part external item identifiers. The R-Net to Business systems adapter provides the reverse translation for inbound transactions. The internal systems may operate using the internal item identifier and all transactions with trading partners can be conducted using the two-part item identifier claims

I claim:

1. An item identifier for a configurable item consisting of a fixed length segment and a variable length segment where the fixed length segment identifies the seller of the item and the variable length segment identifies the configuration of the item.

2. The item identifier of claim 1 wherein the variable length segment is generated in response to a request with a description of the item.

3. The item identifier of claim 1 wherein the item identifier is used in a purchase order to order the item.

4. The item identifier of claim 1 wherein the fixed length segment is the Global Trade Item Number, GTIN, (and its successors) of the item seller.

5. The item identifier of claim 1 wherein the variable length segment is derived from the item seller's algorithm to generate a one part item identifier based on the description of the item.

6. The item identifier of claim 1 wherein the seller uses the variable length segment to identify the item configuration to deliver the item in response to an order for the item using the item identifier.

7. The item identifier of claim 1 wherein an internal item identifier is associated with the item identifier and the item identifier is replaced with the internal item identifier for inbound transactions.

8. The item identifier of claim 1 wherein an internal item identifier is associated with the item identifier and the internal item identifier is replaced with the item identifier for outbound transactions.

9. The item identifier of claim 1, a Web browser and a catalog both connected to a network wherein the Web browser uses the network to send a request with an item description to the catalog and the catalog responds with the item identifier of the item matching the description.

10. The item identifier of claim 1, a Business-to-business server and a catalog both connected to network wherein the Business-to-business server uses the network to send a request with an item description to the catalog and the catalog responds with the item identifier of the item matching the description.

11. The item identifier of claim 1, a Web browser and a catalog both connected to a network wherein the Web browser uses the network to send a request with an item description to the catalog and the catalog responds with the item identifier of the item matching the description and the Web browser is used to associated the item identifier with an internal item identifier.

12. The item identifier of claim 1, a Business-to-business server and a catalog both connected to network wherein the Business-to-business server uses the network to send a request with an item description to the catalog and the catalog responds with the item identifier of the item matching the description and the item identifier is associated with an internal item identifier.

13. An item catalog with descriptions of configurable items that receives a description of an item and responds with a two-part item identifier for an item matching the description wherein the two-part item identifier consists of a fixed length segment identifying the seller of the item and a variable length segment identifying the configuration of the item.

14. The item catalog of claim 13 wherein the two-part item identifier is used in a purchase order to purchase the item matching the description.

15. The item catalog of claim 13 wherein the fixed length segment of the two-part item identifier is the Global Trade Item Number, GTIN, (and its successors) of the item seller.

16. The item catalog of claim 13 wherein the variable length segment of the two-part item identification is derived from the item seller's algorithm to generate a one part item identifier based on the description of the item.

17. An Order Processing system for configurable items that receives a purchase order with a two-part item identifier for a configurable item to be delivered wherein the two-part item identifier consists of a fixed length segment identifying the seller of the item and a variable length segment identifying the configuration of the item and the Order Processing system uses the two-part item identifier to determine the configuration of the item to be delivered.

18. The Order Processing system of claim 17 wherein the two-part item identifier was generated by a catalog in response to a request with the description of the configurable item.

19. The Order Processing system of claim 17 wherein the fixed length segment of the two-part item identifier is the Global Trade Item Number, GTIN, (and its successors) of the seller of the item.

20. The Order Processing system of claim 17 wherein the variable length segment of the two-part item identifier is derived from the item seller's algorithm to generate a one part item identifier based on the description of the item.
